(19) United States
(12) Patent Application Publication
(10) Pub. No.: US 2008/0083003 A1
(43) Pub. Date: Apr. 3, 2008

(54) SYSTEM FOR PROVIDING PROMOTIONAL CONTENT AS PART OF SECONDARY CONTENT ASSOCIATED WITH A PRIMARY BROADCAST

(76) Inventors: BRYAN BINIAK, Los Angeles, CA (US); CHRIS CUNNINGHAM, Los Angeles, CA (US); ATANAS IVANOV, Sania Monica, CA (US); JEFFREY MARKS, Sherman Oaks, CA (US); BROCK MELTZER, Los Angeles, CA (US)

Correspondence Address: DLA PIPER US LLP, 1999 AVENUE OF THE STARS, SUITE 400, LOS ANGELES, CA, 90067-6023, US

(21) Appl. No.: 11/849,238

(22) Filed: Aug. 31, 2007

Related U.S. Application Data
(63) Continuation-in-part of application No. 11/540,748, filed on Sep. 29, 2006.

(51) Int. Cl. H04N 7/173

(52) U.S. Cl. 725/110

(57) ABSTRACT

The system provides a computer based presentation of promotional content synchronized to a broadcast and not merely to an event. The system includes a customizable interface that uses a broadcast and a plurality of secondary sources to present data and information to a user to enhance and optimize a broadcast experience. The system provides customizable delivery of the promotional content that is based on both the content and the context of the primary content broadcast. The contextual triggers define a state of the broadcast and select from a library of promotional content that is appropriate for that state and for the user. The system can also synchronize promotional content to any or all of the plurality of secondary sources as well. The system can provide promotional content on a user by user basis, providing uniquely user directed advertising.

### RELATED APPLICATIONS

This is a continuation-in-part of, and claims priority to, pending U.S. patent application Ser. No. 11/540,748 filed Sep. 29, 2006 and entitled “Social Media Platform and Method” which is incorporated in its entirety herein.

### FIELD OF THE INVENTION

The invention relates generally to a system and method for providing promotional content as a secondary source in coordination with a primary source broadcast.

### BACKGROUND OF THE INVENTION

The television broadcast experience has not changed dramatically since its introduction in the early 1900s. In particular, live and prerecorded video is transmitted to a device, such as a television, liquid crystal display device, computer monitor and the like, while viewers passively engage.

With broadband Internet adoption and mobile data services hitting critical mass, television is at a cross roads faced with:
Declining Viewership
Degraded Ad Recognition
Declining Ad Rates & Spend
Audience Sprawl
Diversionary Channel Surfing
Imprecise and Impersonal Audience Measurement Tools
Absence of Response Mechanism
Increased Production Costs

In addition, there is a tremendous increase in the number of people that have high speed (cable model, DSL, broadband, etc.) access to the internet so that it is easier for people to download content from the internet. There has also been a trend in which people are accessing the Internet while watching television. Thus, it is desirable to provide a parallel programming experience that is a reinvograted version of the current television broadcast experience that incorporates new Internet based content.

Attempts have been made in the prior art to provide a computer experience coordinated with an event on television. For example, there are devices (such as the “slingbox”) that allow a user to watch his home television on any computer. However, this is merely a signal transfer and there are no additional features in the process.

Another approach is to supplement a television program with a simultaneous internet presentation. An example of this is known as “enhanced TV” and has been promoted by ABC. During an enhanced TV broadcast, such as of a sporting event, a user can also log onto abc.com to participate in a preprogrammed and or preproduced content and applications that have been created explicityly for a synchronous experience with the broadcast. The underlining disadvantage to this approached is that the user is limited to only the data made available by the website, and has no ability to customize or personalize the data that is being associated with the broadcast.

Other approaches include gamecasts providing historical and post-play statistical data, and asynchronous RSS widgets.

Another disadvantage of current attempts is an inability to coordinate promotional material (e.g. advertising) to either the primary content source or to the secondary content source. A primary broadcast typically has promotional material included as part of the broadcast, but the promotional content is planned in advance, is not tied to the context of the event or broadcast, the viewer, provides no engagement mechanism and is not customizable to or by the user. All viewers of a particular channel receive the same promotional material. The secondary content may include promotional material as well in the current systems, but this promotional content is at best altered based on geography and is not synchronized to the context or content of the primary or secondary content.

All of the prior art systems lack customizable tuning of secondary content, user alerts, social network integration, interactivity, user generated content, and synchronization to a broadcast instead of to an event.

### SUMMARY

The system provides a computer based presentation of promotional content contextually synchronized to a broadcast and not merely to an event. The system includes a customizable interface that uses a broadcast and a plurality of secondary sources to present data and information to a user to enhance and optimize a broadcast experience. The system provides customizable delivery of the promotional content that is based on both the content and the context of the primary content broadcast. The contextual triggers define a state of the broadcast and select from a library of promotional content that is appropriate for that state and for the user. The system can also synchronize promotional content to any or all of the plurality of secondary sources as well. The system can provide promotional content on a user by user basis, providing uniquely user directed advertising.

### BRIEF DESCRIPTION OF THE DRAWINGS

FIG. 1 illustrates the high level flow of information and content through the Social Media Platform;

FIG. 2 illustrates the content flow and the creation of generative media via a Social Media Platform through the real-time extraction of meta data from the broadcast;

FIG. 3 illustrates the detailed platform architecture components of the Social Media Platform for creation of generative media and parallel programming shown in FIG. 2; and

FIGS. 4-6 illustrate an example of the user interface for an implementation of the Social Media Platform and the Parallel Programming experience.

FIG. 7 is a flow diagram illustrating the generation of a database of triggers for a broadcast event.

FIG. 8 is a flow diagram illustrating a text based trigger in an embodiment of the system.

FIG. 9 is a flow diagram illustrating a contextual trigger in an embodiment of the system.

FIG. 10 is a block diagram of one embodiment of a template structure of the system.

FIG. 11 is a flow diagram illustrating the operation of time based promotional content presentation in an embodiment of the system.

FIG. 12 is a flow diagram illustrating the operation of a trigger based promotional content presentation system in an embodiment of the system.

FIG. 13 is a flow diagram illustrating the operation of an embodiment of the system that uses context.

FIG. 14 illustrates an embodiment of a widget in the system.

FIG. 15 is a flow diagram illustrating content interaction in an embodiment of the system.

FIG. 16 is a functional block diagram of an embodiment of the system.

### DETAILED DESCRIPTION

The invention is particularly applicable to a Social Media Platform in which the source of the original content is a broadcast television signal and it is in this context that the invention will be described. It will be appreciated, however, that the system and method has greater utility since it can be used with a plurality of different types of original source content.

The ecosystem of the Social Media Platform may include primary sources of media, generative media, participatory media, generative programming, parallel programming, and accessory devices. The Social Media Platform uses the different sources of original content to create generative media, which is made available through generative programming and parallel programming (when published in parallel with the primary source of original content). The generative media may be any media connected to a network that is generated based on the media coming from the primary sources. The generative programming is the way the generative media is exposed for consumption by an internal or external system. The parallel programming is achieved when the generative programming is contextually synchronized and published in parallel with the transmitted media (source of original content). The participatory media means that third parties can produce generative media, which can be contextually linked and tuned with the transmitted media. The accessory devices of the Social Media Platform and the parallel programming experience may include desktop or laptop PCs, Internet enabled game consoles and set-top boxes, mobile phones, PDAs, wireless email devices, handheld gaming units and/or PocketPCs that are the new remote controls.

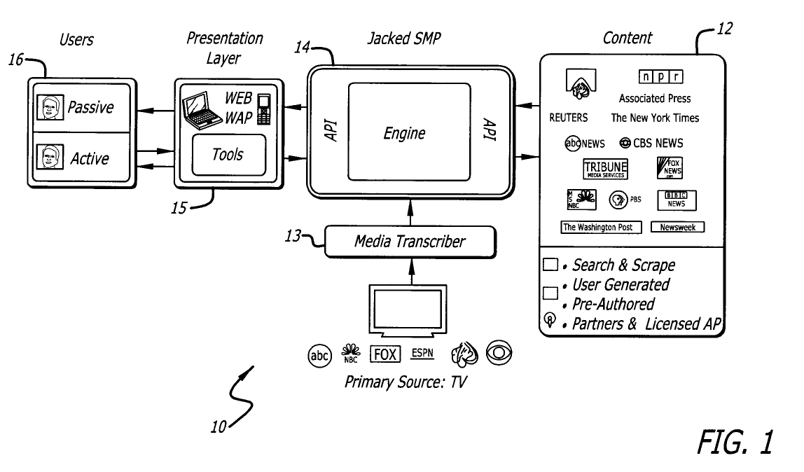

FIG. 1 illustrates the high level flow of information and content through the Social Media Platform 8. The platform may include an original content source 10, such as a television broadcast, with a contextual secondary content source 12, that contains different content wherein the content from the original content source is synchronized with the content from the contextual content source so that the user views the original content source while being provided with the additional content contextually relevant to the original content in real time.

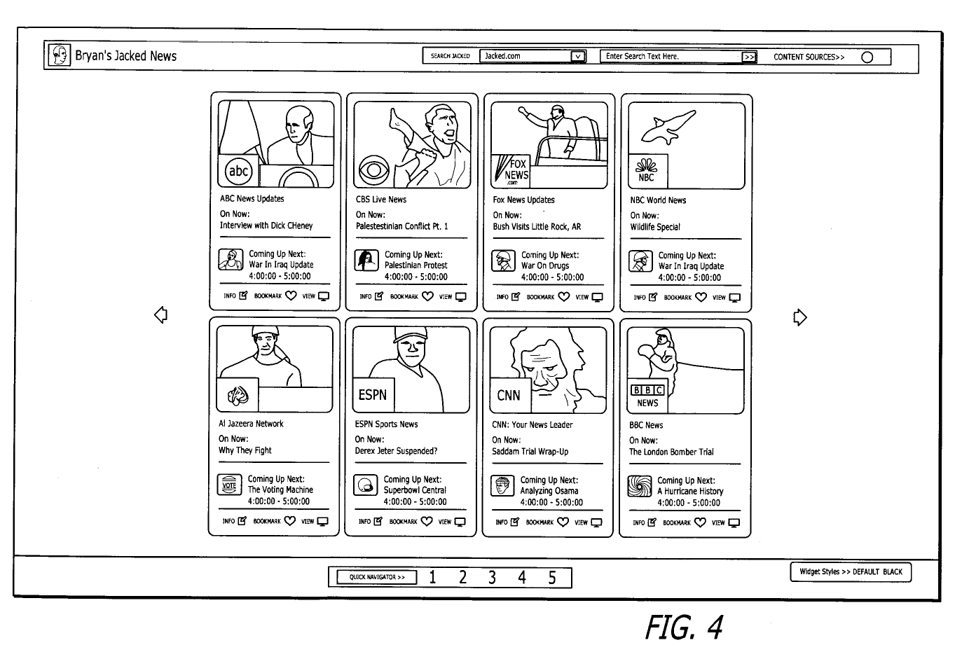

The contextual content source 12 may include different types of contextual media including text, images, audio, video, advertising, commerce (purchasing) as well as third party content such as publisher content (such as Time, Inc., XML), web content, consumer content, advertiser content and retail content. An example of an embodiment of the user interface of the contextual content source is described below with reference to FIGS. 4-6. The contextual content source 12 may be generated/provided using various techniques such as search and scrape, user generated, pre-authored and partner and licensed material.

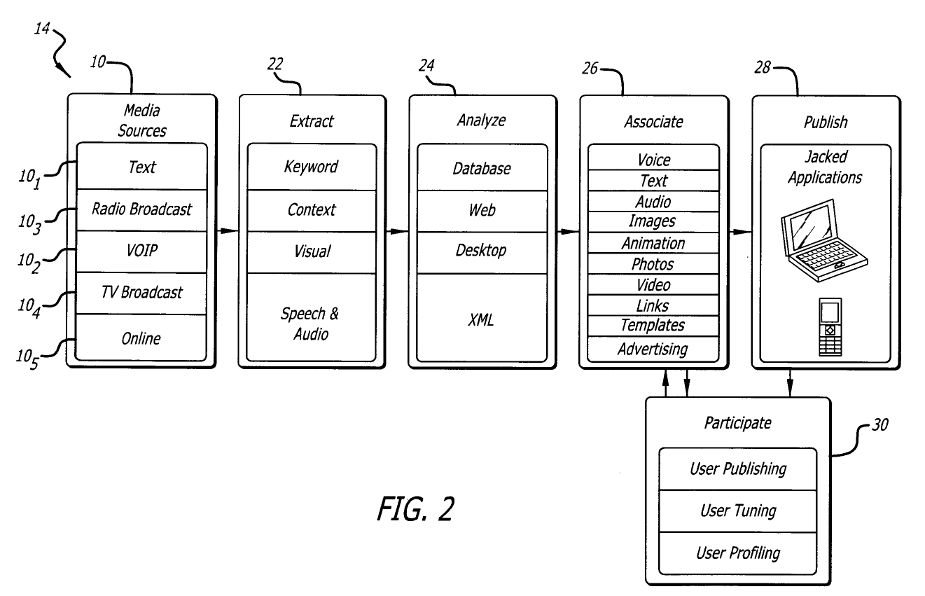

The original/primary content source 10 is fed into a media transcriber 13 that extracts information from the original content source which is fed into a social media platform 14 that contains an engine and an API for the contextual content and the users. The Social Media Platform 14 at that point extracts, analyzes, and associates the Generative Media (shown in more detail in FIG. 2) with content from various sources. Contextually relevant content is then published via a presentation layer 15 to end users 16 wherein the end users may be passive and/or active users. The passive users will view the original content in synchronization with the contextual content while the active users will use tools made accessible to the user to tune content, create and publish widgets, and create and publish dashboards. The users may use one device to view both the original content and the contextual content (such as television in one embodiment) or use different devices to view the original content and the contextual content (such as on a web page as shown in the examples below of the user interface).

The social media platform uses linear broadcast programming (the original content) to generate participative, parallel programming (the contextual/secondary content) wherein the original content and secondary content may be synchronized and delivered to the user. The social media platform enables viewers to jack-in into broadcasts to tune and publish their own content. The social media platform also extends the reach of advertising and integrates communication, community and commerce together.

FIG. 2 illustrates content flow and creation of generative media via a Social Media Platform 14. The system 14 accesses the original content source 10 and the contextual/secondary content source 12 shown in FIG. 1. As shown in FIG. 2, the original content source 10 may include, but is not limited to, a text source 10₁, such as Instant Messaging (IM), SMS, a blog or an email, a photo slideshow, a video, an animation, a voice over IP source 10₂, a radio broadcast source 10₃, a television broadcast source 10₄ or a online broadcast source 10₅, such as a streamed broadcast. Other types of original content sources may also be used (even those yet to be developed original content sources) and those other original content sources are within the scope of the invention since the invention can be used with any original content source as will be understood by one of ordinary skill in the art. The original content may be transmitted to a user over various medium, such as over a cable, and displayed on various devices, such as a television attached to the cable, since the system is not limited to any particular transmission medium or display device for the original content. The secondary source 12 may be used to create contextually relevant generative content that is transmitted to and displayed on a device 28 wherein the device may be any processing unit based device with sufficient processing power, memory and connectivity to receive the contextual content. For example, the device 28 may be a personal computer or a mobile phone (as shown in FIG. 2), but the device may also be PDAs, laptops, Internet enabled game consoles or set-top boxes, wireless email devices, handheld gaming units and/or PocketPCs. The invention is also not limited to any particular device on which the contextual content is displayed.

The social media platform 14, in this embodiment, may be a computer implemented system that has one or more units (on the same computer resources such as servers or spread across a plurality of computer resources) that provide the functionality of the system wherein each unit may have a plurality of lines of computer code executed by the computer resource on which the unit is located that implement the processes and steps and functions described below in more detail. The social media platform 14 may capture data from the original content source and analyze the captured data to determine the context/subject matter of the original content, associate the data with one or more pieces of contextual data that is relevant to the original content based on the determined context/subject matter of the original content and provide the one or more pieces of contextual data to the user synchronized with the original content. The social media platform 14 may include an extract unit 22 that performs extraction functions and steps, an analyze unit 24 that performs an analysis of the extracted data from the original source, an associate unit 26 that associates contextual content with the original content based on the analysis, a publishing unit 28 that publishes the contextual content in synchronism with the original content and a participatory unit 30.

The extraction unit 22 captures the digital data from the original content source 10 and extracts or determines information about the original content based on an analysis of the original content. The analysis may occur through keyword analysis, context analysis, image recognition, visual search and speech/audio recognition analysis. For example, the digital data from the original content may include close captioning information or metadata associated with the original content that can be analyzed for keywords and context to determine the subject matter of the original content including the who, what, where, why, when and how of the source material as well as emotional context. As another example, the image information in the original content can be analyzed by a computer, such as by video optical character recognition to text conversion, to generate information about the subject matter of the original content. Similarly, the audio portion of the original content can be converted using speech/audio recognition to obtain textual representation of the audio. The extracted closed captioning and other textual data is fed to an analysis component which is responsible for extracting the topic and the meaning of the context. The extract unit 22 may also include a mechanism to address an absence or lack of close caption data in the original content and/or a mechanism for addressing too much data that may be known as “informational noise.”

Once the keywords/subject matter/context of the original content is determined, that information is fed into the analyze unit 24 which may include a contextual search unit which may be known as search casting. The analysis unit 24 may perform one or more searches, such as database searches, web searches, desktop searches and/or XML searches, to identify contextual content in real time that is relevant to the particular subject matter of the original content at the particular time. The resultant contextual content, also called generative media, is then fed into the association unit 26 which generates the real-time contextual data for the original content at that particular time. As shown in FIG. 2, the contextual data may include, for example, voice data, text data, audio data, image data, animation data, photos, video data, links and hyperlinks, templates and/or advertising.

The participatory unit 30 may be used to add other third party/user contextual data into the association unit 26. The participatory contextual data may include user publishing information (information/content generated by the user or a third party), user tuning (permitting the user to tune the contextual data sent to the user) and user profiling (that permits the user to create a profile that will affect the contextual data sent to the user). An example of the user publishing information may be a voiceover of the user which is then played over the muted original content. For example, a user who is a baseball fan might do the play-by-play for a game and then play his play-by-play while the game is being played wherein the audio of the original announcer is muted which may be known as fan casting.

The publishing unit 28 may receive data from the association unit 26 and interact with the participatory unit 30. The publishing unit 28 may publish the contextual data into one or more formats that may include, for example, a proprietary application format, a PC format (including for example a website, a widget, a toolbar, an IM plug-in or a media player plug-in) or a mobile device format (including for example WAP format, JAVA format or the BREW format). The formatted contextual data is then provided, in real time and in synchronization with the original content, to the devices 16 that display the contextual content.

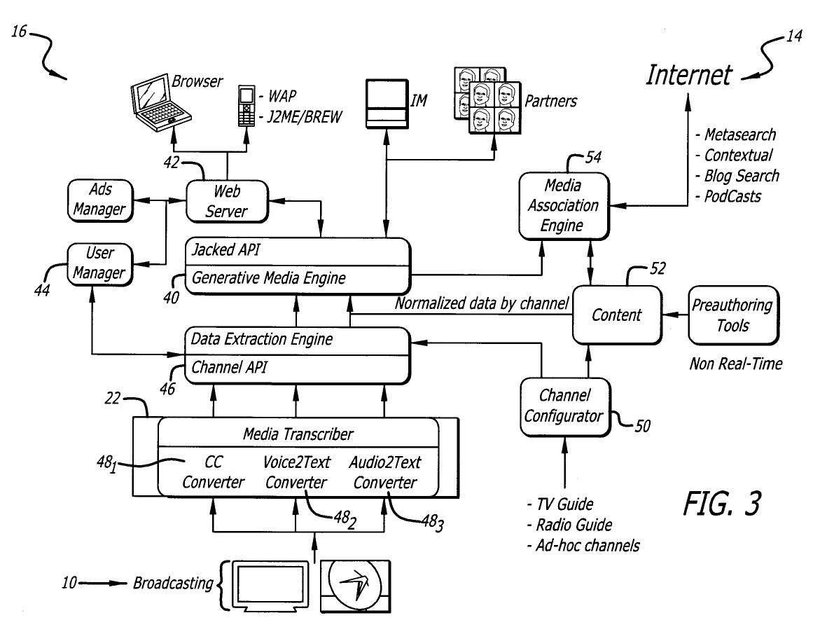

FIG. 3 illustrates more details of the Social Media Platform for creation of generative media and parallel programming shown in FIG. 2 with the original content source 10, the devices 16 and the social media platform 14. The platform may further include a Generative Media engine 40 (that contains a portion of the extract unit 22, the analysis unit 24, the associate unit 26, the publishing unit 28 and the participatory unit 30 shown in FIG. 2) that includes an API wherein the IM users and partners can communicate with the engine 40 through the API. The devices 16 communicate with the API through a well known web server 42. A user manager unit 44 is coupled to the web server to store user data information and tune the contextual content being delivered to each user through the web server 42. The platform 14 may further include a data processing engine 46 that generates normalized data by channel (the channels are the different types of the original content) and the data is fed into the engine 40 that generates the contextual content and delivers it to the users. The data processing engine 46 has an API that receives data from a close captioning converter unit 48₁ (that analyzes the close captioning of the original content), a voice to text converter unit 48₂ (that converts the voice of the original content into text) so that the contextual search can be performed and an audio to text converter unit 48₃ (that converts the voice of the original content into text) so that the contextual search can be performed wherein each of these units is part of the extract unit 22. The close captioning converter unit 48₁ may also perform filtering of “dirty” close captioning data such as close captioning data with misspellings, missing words, out of order words, grammatical issues, punctuation issues and the like.

The data processing engine 46 also receives input from a channel configurator 50 that configures the content for each different type of content. The data from the original content and the data processed by the data processing engine 46 are stored in a data storage unit 52 that may be a database. The database also stores the channel configuration information, content from the preauthoring tools (which is not in realtime) and search results from a search coordination engine 54 used for the contextual content. The search coordination engine 54 (part of the analysis unit 24 in FIG. 2) coordinates the one or more searches used to identify the contextual content wherein the searches may include a metasearch, a contextual search, a blog search and a podcast search.

FIGS. 4-6 illustrate an example of the user interface for an implementation of the Social Media Platform. For example, when a user goes to the system, the user interface shown in FIG. 4 may be displayed. In this user interface, a plurality of channels (such as Fox News, BBC News, CNN Breaking News) are shown wherein each channel displays content from the particular channel. It should be noted, that each of the channels may also be associated with one or more templates to present the secondary source data to the user. The templates may be automatically selected based on the broadcast on that channel, or may be manually selected by the user.

Although the interface of FIG. 4 is illustrated as a plurality of available channels such as is consistent with the operation of a television, it should be understood that the interface can be configured by event or even type of event. For example, one tile could represent football with drill down possibilities to college or pro football, and drill down to all available games in each sport.

When a user selects the Fox News channel, the user interface shown in FIG. 5 is displayed to the user which has the Fox News content (the original content) in a window along with one or more contextual windows that display the contextual data that is related to what is being shown in the original content. In this example, the contextual data may include image slideshows, instant messaging content, RSS text feeds, podcasts/audio and video content. The contextual data shown in FIG. 5 is generated in real-time by the Generative Media engine 40 based on the original content capture and analysis so that the contextual data is synchronized with the original content. FIG. 6 shows an example of the webpage 60 with a plurality of widgets (such as a “My Jacked News” widget 62, “My Jacked Images” widget, etc.) wherein each widget displays contextual data about a particular topic without the original content source being shown on the same webpage.

### Widgets

A widget is a presentation module that presents secondary content to the user. The presentation of the content may be based on triggers or it may be independent of triggers. In some cases the presentation of content is time dependent. In other cases the presentation of content is generated by third parties and is related only to the generation of new content by those third parties. In one embodiment, the user can have a plurality of widgets on a computer display, with each widget providing a particular type of content. The system allows the user to select from a plurality of widgets and to arrange them on a display desktop as desired. FIG. 6 is an example of a number of widgets that are arranged on the user's desktop. The weather widget, for example, presents information that is not tied to triggers from the broadcast but is presenting weather information that is based on forecasting information from a weather service.

The video clip widget presents a dynamically changing selection of video clips that are trigger based in one embodiment of the system. The video widget presents a list of available video clips that the user may choose to activate and watch as desired. The widget includes a scroll bar so that all of the offered video clips can be scanned at played independently of when they were offered for presentation. In one embodiment, when a trigger is detected, a search is undertaken for video that is relevant to the trigger. In some embodiments, all relevant video is offered. In other embodiments, the relevance is ranked pursuant to a relevance algorithm and only the first few are offered. In still other embodiments, only one clip is offered per trigger.

A chat widget, such as is shown in FIG. 6, is typically trigger independent and is broadcast dependent only in the sense that the participating chatters are likely to be talking about things that are happening in the event broadcast. However, in one embodiment, the chat transcript can be searched just as the cc text is searched and the chat transcript itself can provide triggers to the other widgets.

FIG. 6 also includes an image widget that displays a series of images based on triggers and a podcast widget that offers podcasts based on triggers. The widgets of FIG. 6 are merely and example of the possible widgets that can be used in the system. The following is a list of widgets that are contemplated for use with the system. The list is by way of example only and other widgets can be used without departing from the scope and spirit of the system.

### Promotional Widgets

The system contemplates the ability to include promotional widgets as part of the secondary sources made available to the user. In one embodiment, the promotional widgets come in a number of forms. They may be standalone widgets that provide a stream of promotional content during the broadcast. Promotional content and applicatons may be embedded in another display widget, such as in a banner that is part of the widget, a “crawl” of text that is part of the widget, or a splash segment that periodically appears in a portion of the widget. Additional promotional content and applicatons may include imags, animation, video, audio, game, polls, trivia, coupon, sweepstake, user generated content, social networking and communication applications. The promotional widget may be embedded in a secondary source widget such that periodically the secondary source content is interrupted by, or shares presentation space with, a promotional message.

Widgets that may be used with the system include, but are not limited to, News Widgets, News Tickers, Stats Tickers, Photo Widgets, Video Widgets, Play By Play, Boxscore, Player Profile, eCommerce Widgets, Scoreboard, Scoreboard of Other Games, Chat, Game Summary, User Generated Media (i.e. Fancasting, Audio, Photos, Video), Rules of the Game, Player Splits, Team Splits, Rate the Ref, User Replay Call, Flash in Flash Widget, Interactive Game Widgets, Poll Widgets, blogging, vlogging, Fan Camera, podcasting, trivia, games, tagging, wiki, fantasy, betting/challenge, weather, maps, presence, social networking, and the like.

### Triggers

Triggers are words, phrases, contexts, images, sounds, user actions, and other phenomena tied to the broadcast and event that will cause the retrieval and presentation of content to the user. The detection of a trigger causes the system to take action on the trigger, determining if there are presentations to the user that can be updated based on the trigger. The triggers are associated with the extraction block 22 and analysis block 24 of FIG. 2.

In one embodiment, the triggers are at a central database that manages the selection and provision of the secondary content of the system. In other cases, the triggers could be stored locally. In some embodiments, the triggers themselves are defined by the system and are made available to all users of the system. For example, for sporting events, the system could build a database of all players on the team as well as all former players, in addition to other key words and phrases that may generate secondary content of interest to the user. This database might be supplemented by user generated keywords or other media types that are of interest to a particular user.

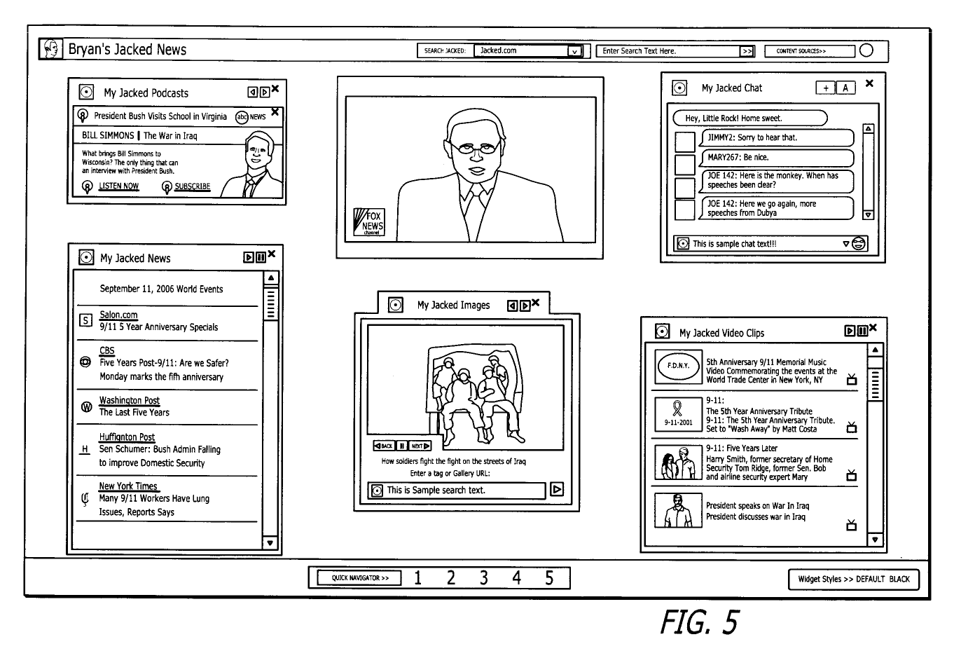

FIG. 7 is a flow diagram illustrating the generation of a database of triggers for a broadcast event. At step 701a central trigger database is created and populated by the system. At decision block 702 it is determined if there are any advertiser suggested triggers to be used for the event. If so, these advertiser triggers are added at step 703. If not, it is determined if there are any user suggested triggers for the event at step 704. If so, the system adds these triggers at step 705. If not the system ends at step 706.

The triggers can take any of several forms, including text triggers, contextual triggers, audio triggers, visual triggers, user actions, and the like.

### Text Triggers

As noted above, the system tracks meta data of a broadcast, including the cc text of a broadcast to look for words and/or phrases that are of interest to the user. This is accomplished by comparing the cc text to a database that includes key words of interest to the user. The database may be generated based on the template the user has selected or may be a predefined database generated by the system based on the type of event that is being broadcast.

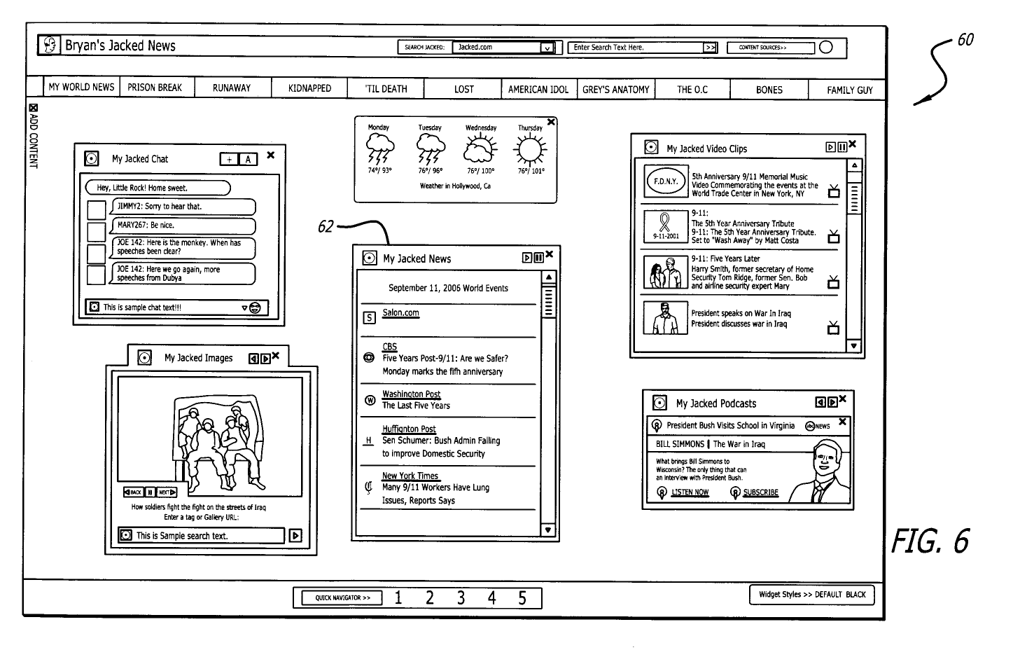

FIG. 8 is a flow diagram illustrating the operation of the system in searching and acting on triggers. At step 801 the system receives the cc text and parses it. At step 802 the system compares the cc text to its database of keywords and phrases. At decision block 803 the system determines if the text is in the database. If not, the system returns to step 801 and continues receiving and analyzing the cc text. If so, the system proceeds to decision block 804 and determines if there is a filter that would block the trigger represented by the database match. This may occur when a user, for example, has indicated a preference for one team (a favorite team). In those cases, the user may not desire to have any information triggered by players or events on the other team. A filter is created to prevent those word hits from triggering an action. When the filter is present, the system returns to step 801.

If there is no blocking filter active at decision block 804 the system proceeds to decision block 805 to determine if there are one or more widgets that can be triggered by the detected word. A widget is a presentation module and is described in more detail below. Depending on which widgets a user has activated, the detected keyword may or may not be usable. For example, if the keyword is one that would trigger a historical video clip in a widget, but the user has no video widgets activated, then no action would take place and the system would return to step 801.

If there are one or more widgets that are appropriate for the detected word, then the system proceeds to step 806 and the appropriate widget or widgets are updated based on the detection of the keyword. The manner in which the widget is updated depends on the nature of the widget itself. After the widget is updated, the system returns to step 801.

Although the above example is given with cc text, the text could come from other sources as well. In fact, certain contemplated widgets themselves may be text based, including IM widgets, blog widgets, newsfeed widgets, statistical widgets, and the like. All sources of text are suitable for review and for mining for textual triggers.

In an alternate embodiment, the step of checking for filters after detection of a word in the database is obviated by filtering the database itself based on user preferences. If the user is not interested in information about the opposing team, all keywords related to the opposing team are removed from the database so that no hits would ever occur based on mention of opposing team members or the opposing team name.

In another alternate embodiment, the widgets themselves have filters such that no update will occur when the trigger consists of an opposing team member or name.

In addition to initiating content presentation, the triggers could also be used to trigger alerts that are sent to destinations defined by the user. For example, even if the user is watching one event, the user may have defined an alert trigger to watch for other players or teams. The system has the capability to monitor a plurality of event broadcasts at one time, and can alert the user when one of these alert triggers has been activated. The alert may be an IM message to the user, a text to the cell phone of the user, an email, a phone call, a pop-up alert, or any other suitable means of providing an alert indication to the user.

Even if the user is not presently logged in to a broadcast using the system, the trigger alert system can be activated so that the user can be alerted to desired information and choose to participate in the system as desired.

### Contextual Triggers

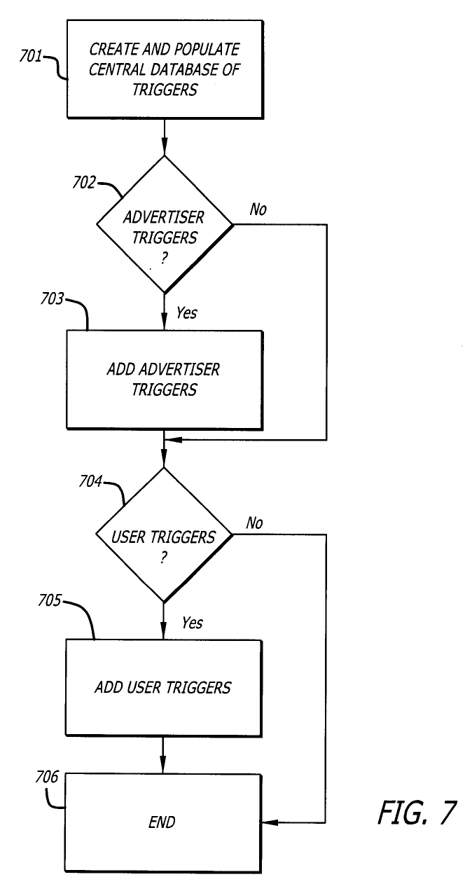

Contextual triggers are based on situations and temporal events associated with the event and can also be used as triggers to update widgets. FIG. 9 is a flow diagram illustrating the operation of contextual widgets. At step 901 the event is analyzed for contextual data. In a game event, this could consist of the score of the game, including the amount by which one team is winning or losing, the time of the game (early or late, near halftime, final two minutes, etc.), the location of the present game or the next game for the user's favorite team, the weather, and the like. At step 902 the system analyzes the data and determines if a contextual trigger exists.

A contextual trigger may be different from other triggers in that it may exist for an extended period of time. In some embodiments, the contextual trigger is used to shade or influence the updates of widgets based on more instantaneous and realtime triggers. At decision block 903 the system checks to see if there are any widgets that can be affected by the contextual trigger. If no, the system returns to step 901. If yes, the system proceeds to step 904 and modifies the widgets so that widget updates reflect the presence of the contextual trigger.

In one embodiment, the contextual triggers react to game situations to influence the activity and output of widgets. For example, if the user's favorite team is winning easily, the user may be very enthusiastic about his team. In that case, the contextual trigger could cause the display of travel advertisements, particularly those directed to attending the next game of the user's favorite team. The contextual trigger could also cause widgets to display other information about the city in which the team has its next game (whether home or away) to further encourage travel or attendance by the user. When the favorite team is losing badly, the contextual trigger may cause a widget or widgets to display historical data of more successful moments of the team so that the user can stay interested in observing the system and not so discouraged that the user will end the viewing session. For example, the system could be triggered to display successful comebacks by the favorite team from earlier games or seasons, reminding the user of the possibility of a turnaround.

### Audio/Image Triggers

Other triggers can be audio based. For example, if there is a particular song being played during the broadcast, the system can recognize the song and identify it to the user through a widget and offer a chance for purchase of the song. Sometimes there may be images present during the broadcast that may or may not be discussed by the announcers. However there may be other metadata associated with the image that can be identified by the system and used as a trigger in the system (e.g. the cc text itself may describe the image even if the announcer does not).

### User Action Triggers

Finally the system can recognize user actions and use them as triggers. The widgets and other presentation modules are typically interactive so that interaction by the user with a particular widget may represent information or data that can be used as a trigger to cause widget updates to the same widget or with other widgets.

### Viewer Profile Triggers

A stored viewer profile in association with any of the above triggers would result in a publishing event that may exist independently of user configured, customized, or personalized publishing triggers.

### Sources

The system contemplates a robust and flexible method of incorporating different sources of content to be tied to a broadcast. Some of the sources are trigger driven, some are context driven, some are condition independent, and some are context independent. In addition, some of the sources may be commercial, some may be advertising based, and some may be personal.

A primary source of content is the broadcast itself, including meta data associated with the broadcast, such as cc text, advertisements, and channel guide descriptions. Secondary sources may be from commercial content providers. For example, Stats, Inc. provides statistical information related to sporting events and will provide statistical information related to a particular game. This may include the personal statistics for each player, team statistics, historical statistics, or other data related to the game. In some cases, e.g. a baseball game, the statistical data may be presented in a manner that is tied to the appearance or involvement of each player. For example, when a player is at bat, that player's statistics are provided for presentation. The opposing pitcher may have overall data as well as historical data against the current batter as well as against batters of that type (right handed or left handed) and/or in a particular situation (men on base, late inning, certain number of outs, etc.).

### Promotional Sources

Other commercial sources of content may be advertisers who wish to provide advertisements to the user. For example, a seller of sports apparel may want to advertise jerseys or other branded merchandise related to the teams and players appearing. Particularly if a user has indicated a preference for one team or the other, the sports apparel maker may want to promote that teams branded merchandise to the user. In some cases, such as in some of the contextual triggers noted above, the advertiser may want to promote branded gear related to former players. A widget can also provide real-time retail and customer feedback opportunities.

Additional sources for advertising and retail triggers may be product placement, wardrobe, location, or other commercial triggers derived from primary source meta data extraction or third party database feeds with stored association information.

Also, viewer demographic, consumption, financial other profile data for individuals or groups of individuals can drive advertising and commercial publishing events in a widget.

Other sources may be content sources such as news sites from which stories, images, audio, and/or video can be searched and presented based on a trigger. For example, if a particular player's name is mentioned, a search can be done on that news site to find media associated with that player and can then be presented to the user. In some cases, the content is simply presented as found. In other cases, a title or other indicator of the content is presented and the user has the option of selecting one or more for presentation.

### Filters

The system contemplates the ability to set filters on widgets, sources, and triggers. The filters allow the user to disable certain triggers. The user can disable triggers individually. In addition, the system provides for the ability to filter out large groups of triggers such as by deselecting the opposing team, for example, in a sporting event. In some cases, selecting a favorite team can result in filtering the opposing team whenever the favorite team is playing.

In other cases, the filters can be used to limit the sources of video, chatting, audio, and other widget content. For example, during an event, the user may only want to view video clips of less than a certain length. Thus, all longer video clips will be filtered out and not presented to the user.

As noted above, there are trigger alerts that can be set by the user as well. In some cases, these alerts can be active even when there is no event related to those triggers being broadcast. For example, a user may have a trigger alert for any news stories that mention his favorite player. However, the user may not want all stories that mention the player, so the user might define a filter of stories that are not to be passed when the trigger is activated.

### Template Structure

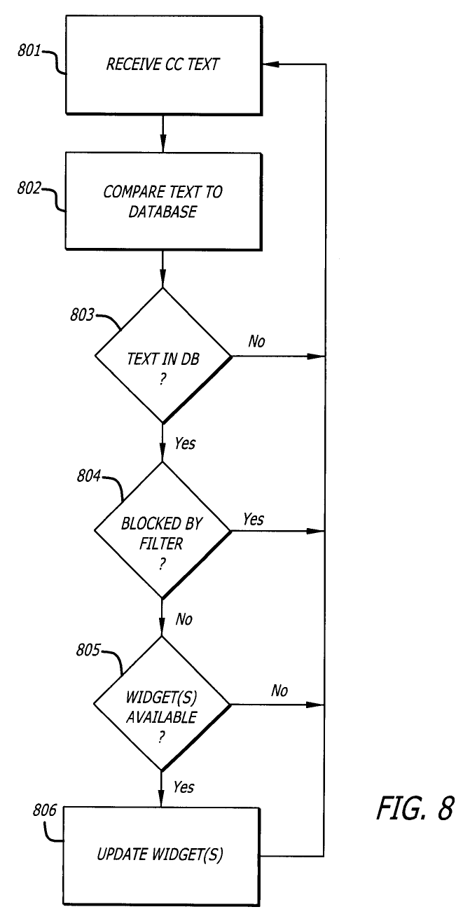

FIG. 10 is a block diagram of one embodiment of a template structure of the system. The template includes a name 1001. Next the template includes a category 1002 and one or more nested subcategories 1003. For example the category could be sports, a subcategory could be football, and two more subcategories could be pro football and college football. A nested template block 1004 includes the names of one or more templates that are referred to and inform the present template. For example, there might be a football template, a college football template, a favorite team template, and a favorite player template that can all be nested to generate a new template. These nested templates can be used in lieu of, or in cooperation with, the categories and subcategories.

The template also includes a listing 1005 of one or more widgets that are to be part of the template. A custom trigger database 1006 is used to enable the user to add custom triggers or keywords to be used with this particular template. A filter 1007 provides the data about filters that are to be used with the template. These filters can be specific or can be conditionally rule based, such as “when my favorite team is playing, filter out the opposing team” or “always filter out Michigan information”.

Region 1008 is used to indicate whether the template is to be sharable or not and region 1009 can be used to indicate the owner or creator of the template.

As noted above, the templates can be shared between users. The templates can be published as well. In some cases, it is contemplated that third parties will create and promote templates for events that can be downloaded and used by a plurality of users. For example, a fan club of a show may generate a template to be offered for use by other fans of the show. In some cases, there may be features of the template that are only available to users of the template. For example, there may be a chat feature that is only activated for users of the template. This allows the system to provide a unique shared experience among users for a broadcast event.

Commercial entities may create and promote templates that include advertising widgets promoting the commercial entity. Some companies may want to include game widgets or contest widgets that encourage user participation during an event broadcast with the chance for some prize or premium for success in the contest.

The activity of the template during an event is stored in a database so that the template can be replayed or searched after the completion of the broadcast. This also encourages sharing of templates. If a user had a particularly good experience during a broadcast, that user may want to share their template with other users.

### Operation of Promotional Presentation

The system contemplates a number of approaches to presenting promotional content as part of the presentation of secondary content to the viewer. Embodiments include, but are not limited to, time based presentation, trigger based presentation, context based presentation, exclusive presentation, shared presentation, and widget based presentation. It should be noted that the system may implement any combination of some or all of these techniques for the presentation of promotional content.

The promotional content may be brand based or commercial based. A brand based approach includes identifying information and lifestyle information related to the promoted brand, but does not include a call to action on the part of the viewer. The brand approach is designed to create awareness of the company providing the promotional content. A commercial based approach typically includes a call to action on the part of the viewer, for example, to purchase a specific product, to act within a certain time frame, or to take advantage of a special offer.

### Time Based Presentation

In one embodiment of the system, the promotional content is provided purely on a timed basis throughout the primary broadcast. The system may present promotional content in some or all of the widgets that a user selects. The system may also require at least one promotional widget as part of every secondary display. The promotional content is displayed for some predetermined time period (e.g. one minute). At the end of each time period, the promotional content is updated with new promotional content. The time based promotional content presentation may be based on a rotation of repeating ads from advertisers who have agreed to participate in the secondary broadcast.

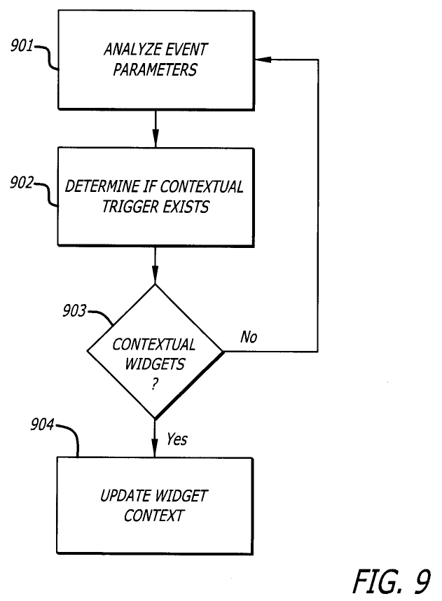

FIG. 11 is a flow diagram illustrating the operation of time based promotional content presentation in an embodiment of the system. At step 1101 the system retrieves promotional content from a database of available content. As noted above, this content may be prepared in advance and stored as modules or files that can be presented as part of a widget, or as a stand-alone widget. At step 1102 all promotional content presentation spaces are updated with new promotional content. At step 1103 the system waits the predetermined time period and then returns to step 1101.

### Trigger Based Presentation

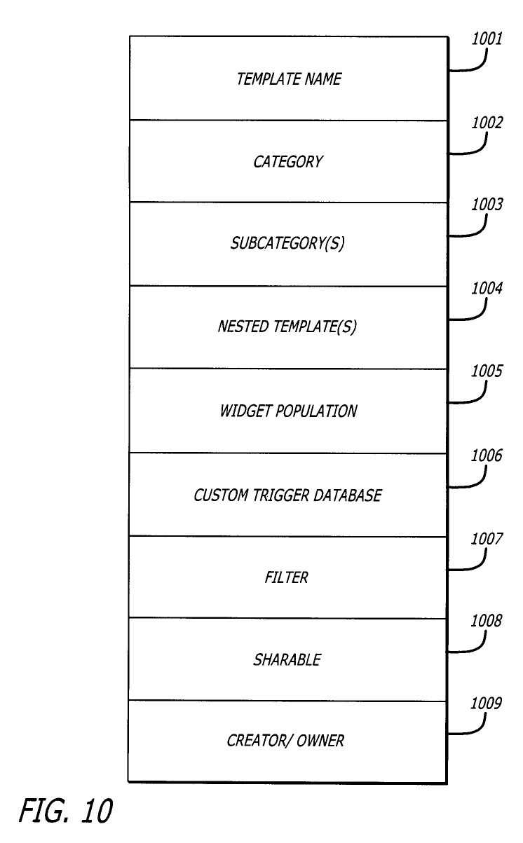

In a trigger based presentation embodiment, promotional content is updated or presented in response to metadata that is associated with the primary or secondary broadcast. FIG. 12 is a flow diagram illustrating the operation of a trigger based promotional content presentation system in an embodiment of the system.

At step 1201, the system tracks metadata from the primary broadcast, such as cc text, audio and video recognition, and other available metadata. In addition, the system tracks metadata available from the secondary contents sources presented via widgets. For example, one widget could be a live chat of a plurality of viewers of the primary broadcast event who are commenting on the primary data source or even on other chatters comments. The chat transcript itself can be mined for metadata and triggers. In some cases, widgets may invite interactive participation from a user. An interaction by the user with the widget can create metadata that can act as a trigger as well.

When a trigger is detected, it is compared at step 1202 to a list of triggers that can initiate the presentation of promotional material. In one embodiment the list of triggers is agreed to in advance of the event by the advertisers. In some cases the triggers are paid for by an advertiser so that all occurrences of the trigger are tied to that advertiser. If the trigger is associated with an advertiser, the system checks the list of on screen widgets at step 1203.

At step 1204 it is determined if the screen widgets are suitable and/or available for promotional content insertion. In some cases the widgets may be committed to already running promotional content or may not be suitable for the presentation of promotional content. If there are widgets available for promotional content, the system moves to step 1205 and analyzes the available widget.

At decision block 1206 the system checks the database of the triggered advertiser and determines if there is promotional content that is appropriate for the widget. For example, if the triggered advertiser only has video content and the widget is only suitable for displaying text, then that widget will not be available for that triggered advertiser. If there is promotional content that is appropriate for the widget at step 1206, the system delivers the promotional content to the widget at step 1207.

If there is no promotional content available for the widget from the triggered advertiser, the system checks at decision block 1208 to determine if there is another advertiser who has requested the trigger. If so, the system returns to step 1206 to determine if that second advertiser has promotional content available that is appropriate for the widget. If so, the system proceeds to step 1207.

After step 1207 or if the decision at step 1208 is no, the system checks at decision block 1209 to see if there are more widgets available for promotional content. If not, the system returns to step 1201. If yes, the system returns to step 1206 to analyze the next available widget. This process continues until all of the possible widgets have been examined for that trigger.

It should be noted that often times there may be product placement in a broadcast, either intentionally or unintentionally (e.g. an announcer happens to mention a product or provider of services). The system, via cc text, audio recognition, or image recognition, can detect these placements and use them as triggers for the presentation of promotional material as well. Another source of triggers are the actual advertisements that may be included in the primary broadcasts. These triggers may provoke ads in the manner as described in FIG. 11 or may, in one embodiment, initiate a counter-promotion response.

In an embodiment that initiates a counter promotion response, when the system detects an advertisement that is part of the primary broadcast, it determines if an advertiser has requested counter promotion on the secondary presentation. For example, if there is a broadcast ad for a car company, say Chevrolet, a competitor such as Ford may request that its ads appear on the secondary source presentation at the same time. In that case the processing of the request would follow the same path as FIG. 11, but the selected advertiser would be the advertiser who requested counter-promotion.

In other cases, where no advertiser has requested counter promotion, the metadata of the ad on the primary broadcast may still trigger ads via the triggers detected in the metadata.

Although the system has been described above in connection with the presence of a single trigger, the system has equal application where multiple triggers are used to provide appropriate promotional content. For example, in one embodiment, the system contemplates that users will be registered members, with certain biographical, geographical, and other personal data associated with the user. In addition to user supplied data, the system may track user preferences based on use of the system for different broadcast events. Finally, the types of widgets that the user selects and/or interacts with may also indicate a certain type of user based on other users who select similar widgets. All of this information is included to form a user profile.

During operation, the system checks the user profile and may use it as a filter to further select appropriate promotional content. The system can then offer custom directed promotional content to each individual user so that no two users necessarily have receive the same promotional content during any one broadcast event. In determining the appropriate content in step 1206 of FIG. 12, one of the factors can include the profile of the user. This profile can be updated continuously based on the activity of the user in selecting and interacting with widgets, selecting broadcast events, events associated with the geographical region of the user, and other related information.

### Context Based Presentation

The system includes an embodiment that ties the promotional content to an emotional state based on content. If the primary broadcast is a sports event, for example, there are contextual moments attached with whether one team is winning or losing. If a user's favorite team is winning, the user might feel more “in the moment”. There are products and types of promotional content that are more appropriate for that user at that time. If the user's favorite team is losing, the promotional content may be more appropriate to be either nostalgic or forward looking, to distract the user from the present bad news.

The system can take advantage of context by allowing an advertiser to create and/or identify ads and promotional content that are appropriate for certain contexts. All promotional content from an advertiser can include a flag, context bit, or some other indicator that allows the system to identify appropriate promotional content.

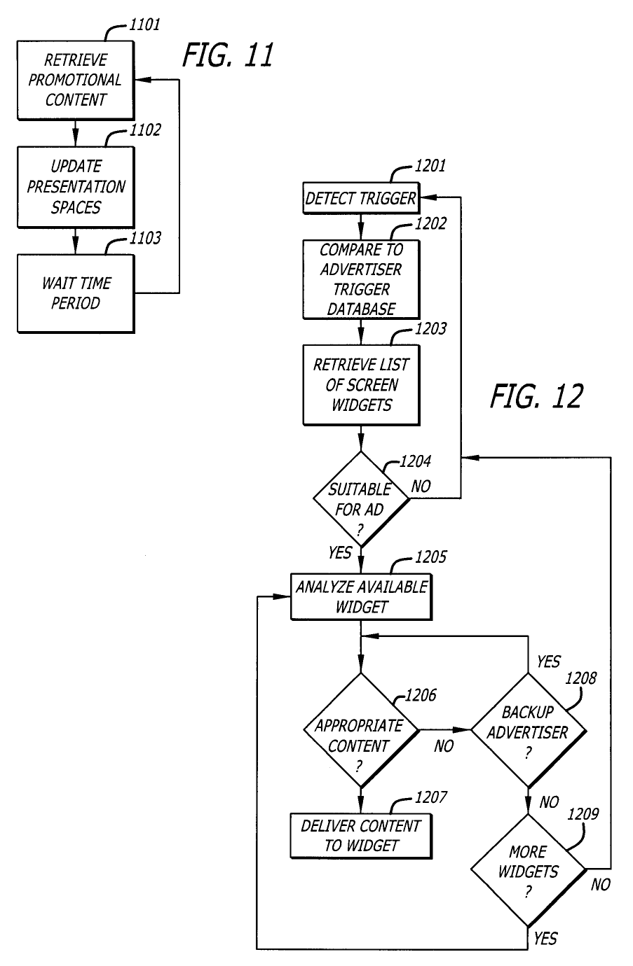

In one embodiment, the system uses content to modify or filter a database of available promotional content based on the context and circumstances of a primary source broadcast. FIG. 13 is a flow diagram illustrating the operation of an embodiment of the system that uses context. At step 1301 the system populates a database with a plurality of promotional content. Each file of promotional content includes a flag that can represent one or more states of possible context. (More than one contextual state may be present at the same time).

At step 1302 the circumstances of the primary source broadcast are monitored. For purposes of example, consider where the event is a sporting event and the user has indicated a preference for one team over the other (i.e. a “favorite team”). Some of the contextual factors that can be considered include whether the favorite team is winning or losing, the amount by which the favorite team is winning or losing, the current time of the game (early or late), the location of the game, and other contextual events.

When one or more contextual events are present, the system can set a filter at step 1303 on the database so that only those files that match the current contextual state are retrieved when the database is queried in response to a trigger. In one embodiment the filter is implemented at the user's computer so that the system can be customized for each individual user. For example, during the same game, the context for a fan of team A is different for the fan of team B. Therefore their respective context triggers will be different (often orthogonal).

With respect to the system of FIG. 12, the context filter can be implemented in steps 1205 and/or 1206. In an alternate embodiment, it is just not the population of promotional content for an advertiser that may be affected by content, but the advertiser itself. There may be contexts where the advertiser does not want any of its promotional content displayed to the user. In that case, all of the advertisers promotional content files are tied to the same context filtering parameters. The context based presentation can be used in connection with any of the schemes for providing promotional content in the system herein.

### Exclusive/Shared Presentation

The system may implement a scheme where each widget can be sponsored exclusively by different advertisers whose promotional content appears in response to specific keywords, triggers, and contexts. In other instances, the system may offer complete exclusivity for all widgets during the primary content broadcast. In other words, one advertiser may be entitled to every ad during the entire secondary content presentation. In other embodiments, an advertiser may have temporal exclusivity. That is, the advertiser may only have exclusivity for a certain period of the broadcast or for certain non-consecutive periods of the broadcast. In other embodiments, the primary broadcast does not have exclusivity for any one advertiser, but is shared by multiple advertisers whose content can appear at the same time in different widgets.

### Secondary Content Widget and Promotional Content Interaction

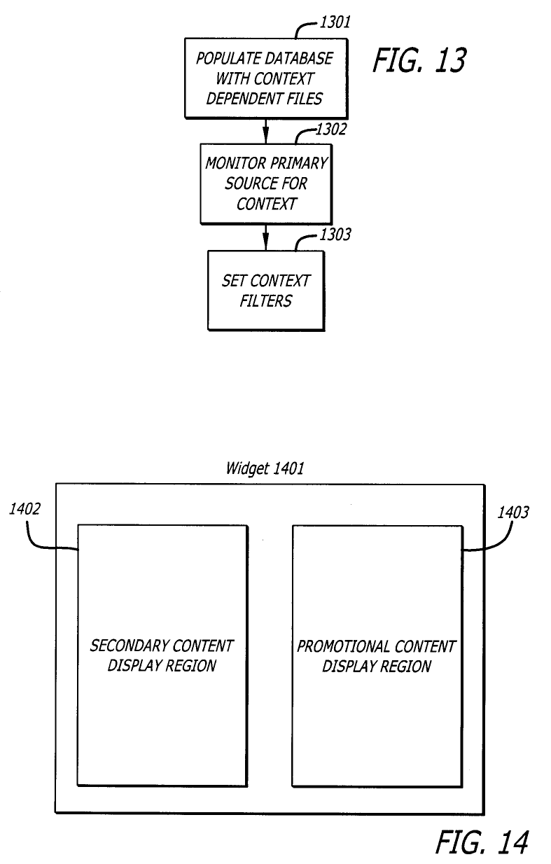

In embodiments of the system, certain widgets provide secondary content that consists of images and/or video. In one embodiment of the system, these widgets include a first display area for secondary content and a second display area for promotional content. An example of such a widget is illustrated in FIG. 14. The widget 1401 in this case has a display region 1402 that is for presenting still images and/or video images of secondary content. Display region 1403 is for presenting text, audio, still and/or video promotional content. An advertiser may desire promotional content to be shown whenever there is the presentation of secondary content in display region 1402. In other embodiments, an advertiser may want to only show promotional material during the presentation of specific secondary content in display area 1401. For example, during a sporting event, an advertiser may only want to display promotional content when a particular player or players are being displayed in region 1401. This allows a connection to be formed in the user's mind of the promotional material with the player or players.

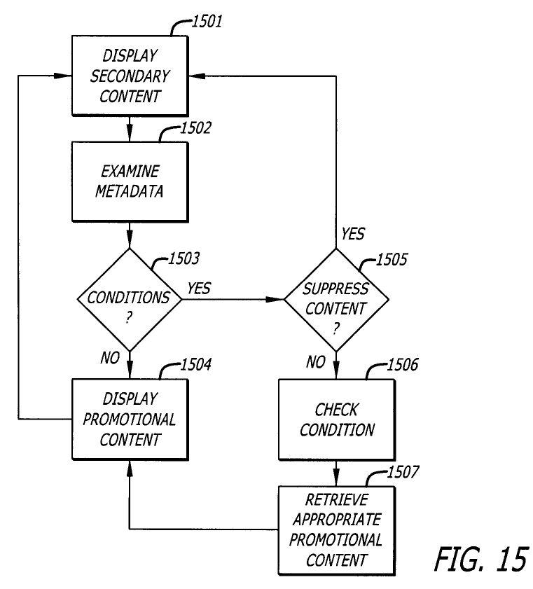

FIG. 15 is a flow diagram illustrating the operation of this content interaction. At step 1501 the system displays secondary content in region 1402. At step 1502 the metadata associated with the secondary content is examined. At decision block 1503 it is determined if there are any conditions associated with the metadata. If not, the system presents promotional content in region 1403 at step 1504 and returns to step 1501.

If there are conditions associated with the metadata at block 1503, the system checks at decision block 1505 if the condition is to suppress promotional content based on the metadata. If so, then no promotional content is supplied and the system returns to step 1501. If not, then the system next checks the condition at step 1506 and retrieves the appropriate promotional content at step 1507. The system then provides the promotional content to region 1403 at step 1504 and returns to step 1501.

Implied endorsements when player images/video/content are associated with promotional content.

### Block Diagram

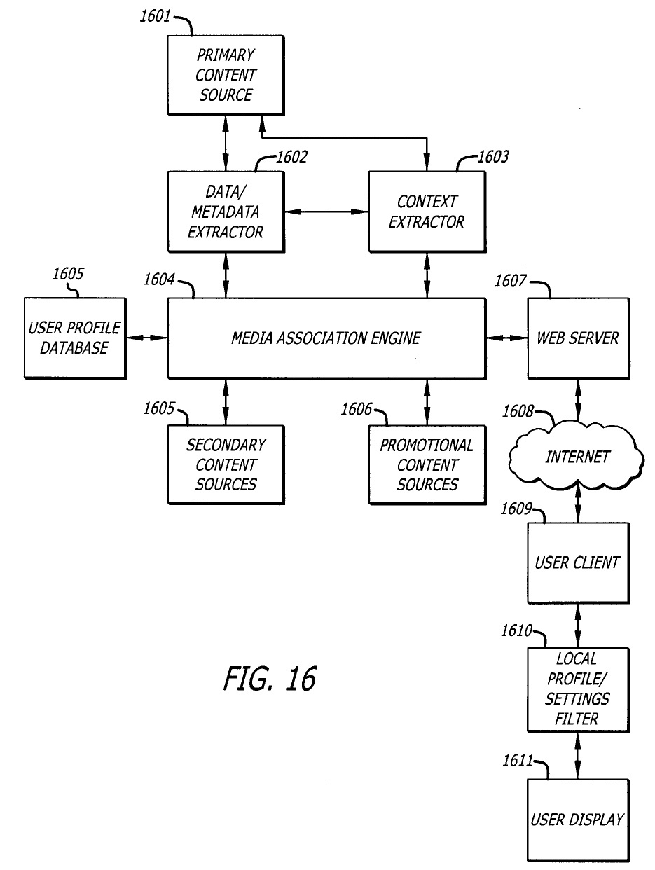

FIG. 16 is a functional block diagram illustrating an embodiment of the system. Block 1601 is the primary content source. The primary content source may be a television broadcast or any other suitable primary content source. The primary content source 1601 is coupled to data/metadata extractor 1602 and context extractor 1603. The data/metadata extractor 1602 extracts metadata such as cc text, audio data, image data, and other related metadata, as well as data from the primary content source itself. The context extractor 1603 is coupled to the primary content source 1601 and to the data/metadata extractor 1602 and is used to extract context information about the primary content source 1601.

The data/metadata extractor 1602 and context extractor 1603 provide output to media association engine 1604. The media association engine 1604 uses the metadata and context data to determine what secondary content and promotional content to be provided to a user. The media association engine 1604 is coupled to a user profile database 1605 which contains profile information about the registered users of the system. The media association engine 1604 provides requests to secondary content source 1605 and promotional content source 1606.

Although secondary content source 1605 is shown a single block in FIG. 16, it is understood that this may be representational. In one embodiment, secondary content sources may be one or more web sites, databases, commercial data providers, or other sources of secondary content. The request for data may be in the form of a query to an internet search engine or to an aggregator web site such as Youtube, Flikr, or other user generated media sources.

The promotional content sources 1606 may be a local database of prepared promotional files of one or more media types, or it could be links to servers and databases of advertisers or other providers of promotional content. In one embodiment, the promotional content may be created dynamically, in some cases by “mashing” portions of the secondary content with promotional content.

The media association engine 1604 assembles secondary content and promotional content to send to users to update user widgets. The assembled content is provided via web server 1607 to a user, such as through the internet 1608. A user client 1609 receives the assembled secondary and promotional content updates and applies a local profile/settings filter 1610. This filter tracks the active widgets of the user, team preferences, client processing capabilities, user profile information, and other relevant information to determine which widgets to update and with which information. User display 1611 displays user selected widgets and are updated with appropriate content for presentation to the user.

While the foregoing has been with reference to a particular embodiment of the invention, it will be appreciated by those skilled in the art that changes in this embodiment may be made without departing from the principles and spirit of the invention, the scope of which is defined by the appended claims.

We claim:

1. A promotional content generation system comprising:
A primary content source;
a metadata detection system coupled to the primary content source for extracting metadata from the primary content source;
a media association engine coupled to the metadata detection system and to a promotional content source for analyzing the metadata and selecting promotional content based on the metadata.

2. The system of claim 1 wherein the primary content source is a broadcast.

3. The system of claim 2 wherein the media detection system analyzes and/or produces the metadata for triggers.

4. The system of claim 3 wherein the trigger comprises close captioned text associated with the broadcast.

5. The system of claim 4 wherein the trigger comprises contextual information associated with the broadcast.

6. The system of claim 4 wherein the trigger comprises audio data associated with the broadcast.

7. The system of claim 4 wherein the selection of the promotional content further depends on a profile of a user accessing the system.

8. The system of claim 7 wherein the media association engine further analyzes a context of the primary content source.

9. The system of claim 8 wherein the selection of promotional content is further dependent on the context of the primary content.

10. The system of claim 9 wherein the system further assembles secondary content based on the metadata and context of the primary content source.
